(19) United States
(12) Patent Application Publication
(10) Pub. No.: US 2008/0223357 A1
(43) Pub. Date: Sep. 18, 2008

(54) SELF-CLEANING COOKING APPLIANCE

(76) Inventors: Janus Bartelick, Germantown, WI (US); William J. Hansen, Pewaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 12/045,032

(22) Filed: Mar. 10, 2008

Related U.S. Application Data
(60) Provisional application No. 60/893,839, filed on Mar. 8, 2007.

(51) Int. Cl. F24C 13/00; B08B 3/00

(52) U.S. Cl. 126/21 A; 134/168 R

(57) ABSTRACT

A method and apparatus for cleaning a cooking apparatus. A self-cleaning cooking apparatus can include a cooking chamber having a plurality of surfaces a food preparation assembly configured to prepare food product within the cooking chamber, a water nozzle positioned to direct water into cooking chamber, a holder configured to hold a detergent packet in a position configured to allow the water to dissolve the detergent from the detergent packet. The holder can be positioned in a drain tank or within the cooking chamber. The liquid within the drain tank can be re-circulated from the drain tank to the nozzle.

### CROSS-REFERENCE TO RELATED APPLICATIONS

This application claims the benefit of U.S. Provisional Patent Application No. 60/893,839 filed on Mar. 8, 2007, the disclosure of which is hereby incorporated by reference as if set forth in its entirety herein.

### STATEMENT REGARDING FEDERALLY SPONSORED RESEARCH

Not Applicable.

### BACKGROUND OF THE INVENTION

This invention is in the general field of cooking appliances, and in particular to a self-cleaning cooking appliance.

Combination ovens provide the ability to cook foods using steam, hot-air convection, or both steam and convection. A motor driven fan is used to circulate air within a cooking chamber past electrical heating elements or gas heat exchange tubes to perform the convection functionality. To produce steam within the cooking chamber, a water line feeds water into the cooking chamber near the heating elements to vaporize the water.

This combination of convection heating with steam provides a system where food can be properly cooked significantly faster than with traditional ovens or even convection ovens alone. As a result, combination ovens have become a vital asset in commercial cooking environments that need to cook food quickly and, often, in large quantities.

Inevitably, the cooking chamber of a combination oven is dirtied during a food preparation process and requires cleaning. Cleaning a cooking chamber can be a time consuming process. This has led to the development of combination ovens with complex cleaning systems. The complex cleaning systems use water and chemicals to clean the cooking chambers. Typically, the complex cleaning systems store chemicals in reservoirs and include expensive chemical pumps that pump the chemicals to the cooking chamber. These chemicals can be unsafe to handle in liquid form.

Therefore, it is desirable to have a cleaning system for a combination oven that that does not require a complex cleaning system with a chemical pump and a chemical reservoir.

### BRIEF SUMMARY OF THE INVENTION

The present invention provides a self-cleaning cooking apparatus including a cooking chamber having a plurality of surfaces, a food preparation assembly configured to prepare food product within the cooking chamber, a water nozzle positioned to direct water into cooking chamber, and a holder configured to hold a detergent packet in a position configured to allow the water to dissolve the detergent from the detergent packet. The detergent packet can be configured to be handled safely. The detergent packet can include a thin membrane enclosing a water-soluble detergent, which can include a cleaning agent and a rinse agent. The cooking chamber can include a drain and the holder can be configured to be placed in the drain. The cooking apparatus can further including a tank positioned below cooking chamber and in fluid communication with the drain, the tank can be configured to hold a predetermined volume of liquid and to allow for liquids to drain from the cooking chamber to the tank, and a a pump configured to pump liquid from the tank to the water nozzle, the cup holds the detergent packet in the volume of liquid in the tank. The cooking apparatus can also include a fresh water line connected to a first valve that is in fluid communication with the nozzle. The fresh water line connected to a second valve that is in fluid communication with the tank. The cup can be a mesh. The plurality of surfaces can include at least one vertical sidewall, the holder being positioned on the at least one vertical sidewall underneath the water nozzle. The holder can be a tray including a plurality of openings.

The present invention also provides a method of cleaning a cooking apparatus including a cooking chamber and a heating assembly. The method can include placing a detergent packet in the cooking apparatus, providing water to the detergent packet to dissolve the detergent packet, and cleaning the cooking chamber with water including detergent dissolved from the detergent packet. The detergent packet can be placed in a tank positioned below the cooking chamber and water can be pumped from the tank to a nozzle that sprays into the cooking chamber. The method can also include steaming the cooking chamber, comprising rinsing the cooking chamber, providing convection heating during the step of cleaning the cooking chamber, drying the cooking chamber, and/or purging the tank. The detergent packet can be placed in a tray positioned on a vertical wall within the cooking chamber. Water can be sprayed from a nozzle into the tray.

### DESCRIPTION OF THE DRAWINGS

FIG. 1 is a perspective view with a partial cut away section of a cooking apparatus incorporating an a cleaning assembly according to an embodiment of the present invention;

FIG. 2 is a close-up view of FIG. 1;

FIG. 3 is a perspective view of the cooking apparatus of FIG. 1 from the front of the apparatus with a partial cut away section;

FIG. 4 is a close-up view of a detergent dispensing dish of FIG. 3;

FIG. 5 shows the detergent dispensing dish of FIG. 4 with a detergent packet;

FIG. 6 is a perspective view of a cooking apparatus incorporating a cleaning assembly according to another embodiment of the present invention from the front of the apparatus with a partial cut away section;

FIG. 7 is a sectional view along line 7-7 of FIG. 6;

FIG. 8 is a flow chart illustrating how a cleaning assembly can be used to clean an oven; and

FIG. 9 is a block diagram of a cooking apparatus including a cleaning assembly.

### DETAILED DESCRIPTION OF THE PREFERRED EMBODIMENTS

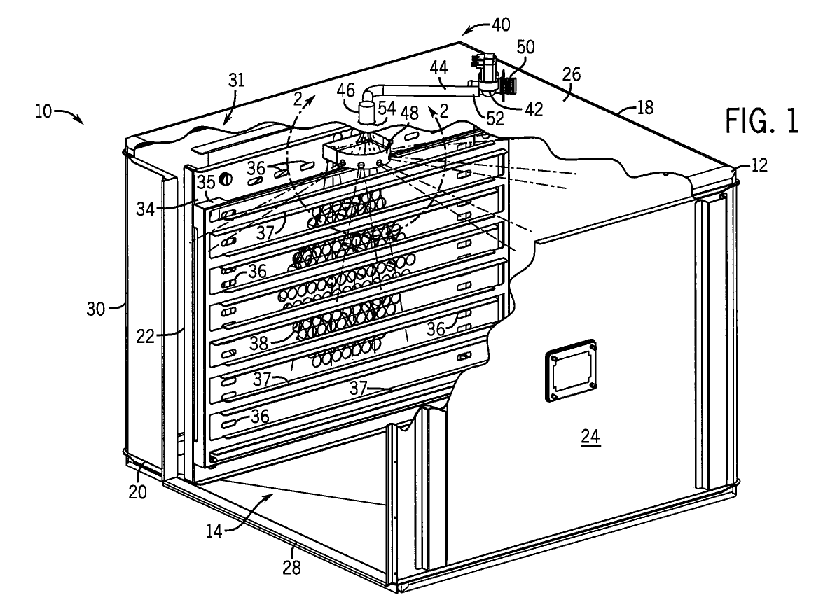

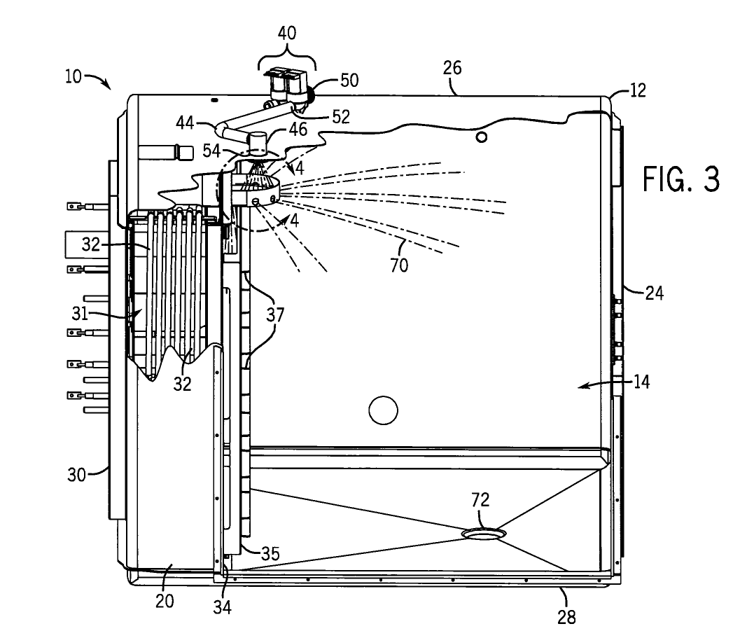

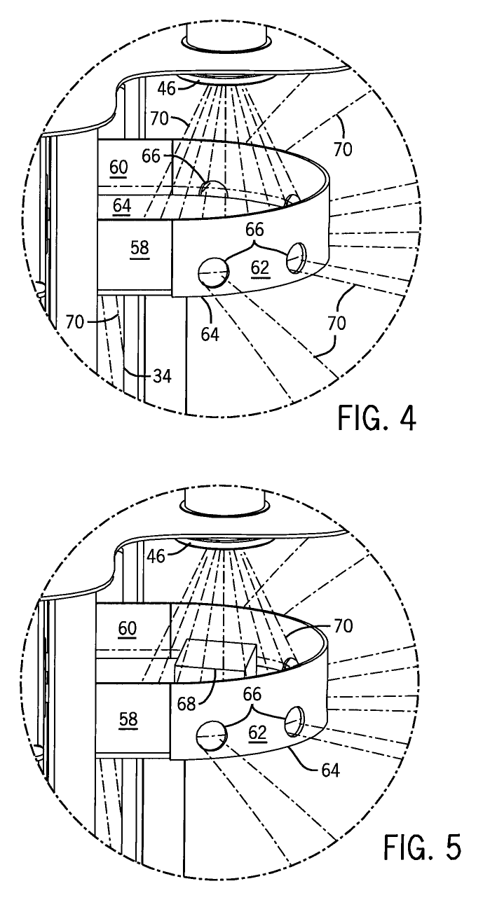

As shown in FIGS. 1-5, a cooking apparatus 10 includes a cleaning system according to an embodiment of the present invention. Cooking apparatus can be, for example, a combination oven. Cooking apparatus includes a housing 12 with a door (not shown) that provides access to a cooking chamber 14 in the interior of the housing 12. The housing 12 includes a back wall 18, a front wall 20, a left side wall 22, a right side wall 24, a top wall 26, a bottom wall 28 and a left exterior side wall 30. The door is hingedly attached to the front wall 20. The exterior of the housing 12 is generally defined by walls 18, 20, 24, 26, 28 and 30. The cooking chamber 14 is generally defined by the door and walls 18, 22, 24, 26 and 28.

Left side wall 20 is offset from an exterior wall 28 of the housing 12 by a sufficient distance in order to provide a heating assembly 31 capable of perform various food preparation methods. Heating assembly 31 is configured to prepare food product using radiant heat, convection and steam heating. Heating assembly 31 includes a radial fan (now shown) with blades that rotate around a hub (not shown), a fan motor (not shown), a heating element 32 looped around the fan blades of the radial fan, and water atomizer (not shown) disposed proximal to the hub of the radial fan. The heating element 32 is a resistive coil. Alternatively, the heating assembly 31 can include a gas burner with gas heat exchange tubes to supply the necessary heat for cooking. In another embodiment, the cooking apparatus 10 can include a smoker assembly and/or a radiant heat assembly. Additionally, a rotisserie assembly can be disposed in the cooking chamber 14.

A cover 34 is attached to left side wall 20 and includes a plurality of apertures 36. The plurality of apertures 36 extend through cover 34 and provide for steam and heated air to flow into cooking chamber 14 for the purposes of preparing food product. The cover 34 includes a grill 38 that is axially aligned with the fan hub to provide an air intake for the fan. A rack support 35 extends from cover 34 and includes a plurality of rack shelves 37 that are offset from cover 34. Right side wall 22 includes a corresponding rack support (not shown) with rack shelves (not shown) that, in addition to rack shelves 37, support cooking racks and trays (not shown) placed within cooking chamber 14.

Heating assembly 31 provides convection heating as described in U.S. Pat. No. 6,157,668, the disclosure of which is hereby incorporate by reference as if set forth in its entirety herein, by heating the heating element 32 while rotating the fan blades to disperse heated air throughout the cooking chamber 14. The air is drawn in through the grill 38, over the heating element 32 and out through the apertures 36 to heat the cooking chamber 14. Heating assembly 31 provides steam heating as described in U.S. Pat. No. 6,188,045, the disclosure of which is hereby incorporated by reference as if set forth in its entirety herein, by directing atomized water past the heating element 32 thereby producing steam that is directed inside the cooking chamber 14. Rotating fan blades cause the atomized water to be directed past the heating element 32 and cause the steam to be directed inside the cooking chamber 14.

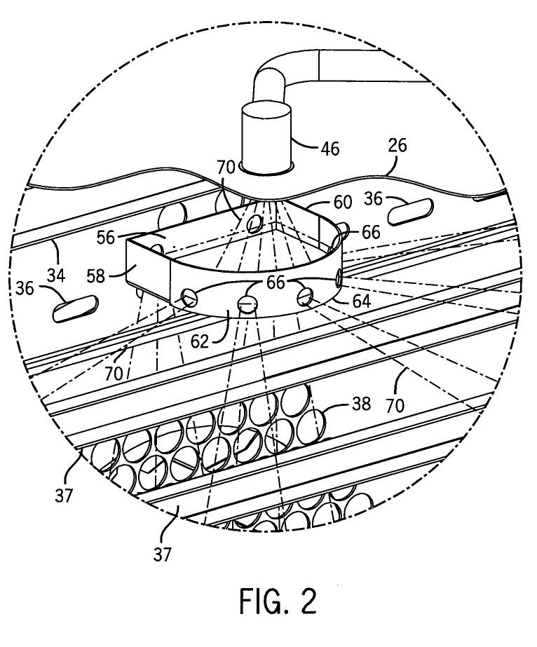

Cooking apparatus 10 includes a cleaning assembly 40 that cleans the cooking chamber 14. Cleaning assembly 40 includes a water valve 42, a water conduit 44, a water nozzle 46 and a cleaning dish 48. Water valve 42 is shown in FIGS. 1 and 2 above housing 12 for clarity, but is actually mounted to the back of cooking apparatus 10. Water valve 42 is a solenoid valve that includes a water inlet 50 that attaches to a water supply line (not shown) and a water outlet 52 that is connected to water conduit 44. The water supply line supplies pressurized clean water. A pump can be used to increase the water pressure. Water nozzle 46 is connected to water conduit 44 and extends through an opening 54 in top wall 26. Water nozzle 46 is a spray-type nozzle that includes a plurality of ports (not shown) through which water is dispersed from water nozzle 46.

Cleaning dish 48 is positioned in cooking chamber 14 beneath water nozzle 46. Referring now to FIGS. 2, 4 and 5, dish 48 includes a dish back wall 56, a dish side wall 58, a dish side wall 60, a dish front wall 62 and a dish bottom 64. Dish back wall 56 and dish side walls 58 and 60 are rectangular. Dish side walls 58 and 60 extend perpendicularly from ends of the dish back wall 56. Dish front wall 62 comprises a partial section of a cylindrical ring. Dish front wall 62 extends from dish side walls 58 and 60. Dish back wall 56, dish side walls 58 and 60 and dish front wall 62 form a continuous perimeter of cleaning dish 48. Dish bottom 64 forms the bottom of dish 48, is perpendicular to walls 56, 58, 60 and 62 and extends between walls 56, 58, 60 and 62. Cleaning dish 48 is open from above. As discussed below, dish front wall 62 includes a plurality of apertures 66 and dish bottom 64 includes at least one aperture (not shown).

Cleaning dish 48 is removably mounted to cover 34 and positioned underneath nozzle 46. Dish 48 includes at least one mounting arm (not shown) configured to be inserted through mounting holes (not shown) formed in cover 34, which allows dish 48 to be removed from cooking chamber 14. When mounted to cover 34, dish back wall 56 is adjacent cover 34 so that dish bottom 64 is parallel to top wall 26. Apertures 66 of dish front wall 62 are positioned towards the interior of cooking chamber 14. The at least one aperture of dish bottom 64 is positioned between cover 34 and rack shelves 37. In an alternative embodiment, cleaning dish 48 can be permanently mounted to cover 34.

To clean the surfaces of cooking chamber 14, a detergent packet 68 (shown in FIG. 5) is first placed in cleaning dish 48 and then cleaning dish 48 is mounted within cooking chamber 14 as described above. Detergent packet 68 has a thin membrane (not shown) that is water permeable. The thin membrane encases cleaning and rinse agents that dissolve in water. The thin membrane is configured to allow for safe handling of detergent packet 68. The thin membrane is also configured to allow water to enter detergent packet 68 to dissolve the cleaning and rinse agents.

Once the cleaning dish 48 with detergent packet 68 is mounted to the cooking chamber 14, the automatic cleaning process can be initiated. The cleaning process is controlled by a controller (not shown) that is configured to control heating assembly 31 and water valve 42. With the door closed, the controller opens water valve 42 and pressurized water 70 is then sprayed out of water nozzle 46 towards cleaning dish 48. Water 70 hits cleaning dish 48 and randomly splashes and sprays around cooking chamber 14 and heating assembly 31 to clean cooking chamber 14 and heating assembly 31. Water 70 also hits detergent packet 68 and dissolves the cleaning and rinse agents within the detergent packet 68. Water 70 carrying the cleaning and rinse agents is randomly sprayed, splashed and splattered throughout cooking chamber 14 and heating assembly 31 to further clean cooking chamber 14 and heating assembly 31. Water 70 carrying the cleaning and rinse agents is also directed out of cleaning dish 48 by dish front wall apertures 66 and the at least one aperture in dish bottom 64. Dish front wall apertures 66 direct water 70 radially outward from cleaning dish 48. The at least one aperture in dish bottom 64 directs water 70 downward along the surface of cover 34. Water 70 splashes around the surfaces of the cooking chamber 14 as well. When water 70 finally reaches the bottom of cooking chamber 14, a drain 72 formed in the a bottom wall 28 allows water 70 containing the cleaning and rinsing agents and encompassing contaminants from cooking camber 14 to exit cooking chamber 14.

While water 70 is being sprayed around cooking chamber 14, the fan of heating assembly 31 can be rotated to aid in the cleaning process. Additionally, heating element 32 can be caused to heat cooking chamber 14 to aid in the cleaning process. The shelves and racks can be left in cooking chamber 14 during the cleaning process.

After a known period of time, all of the cleaning and rinse agents within the detergent packet 68 will have been utilized. The controller then thoroughly rinses cooking chamber 14 with clean water. Rather than just rinse after the known period of time, the controller can also determine when all of the cleaning and rinse agents have been utilized based on the amount of water dispensed during the cleaning process. Chemical sensors can also be used to determine whether any detergent is present in the cooking chamber.

Once cooking chamber 14 has been rinsed, a forced vent system (not shown) can help to speed the drying process. Heating assembly 31 can be controlled to aid the drying process by providing heat to cooking chamber 14.

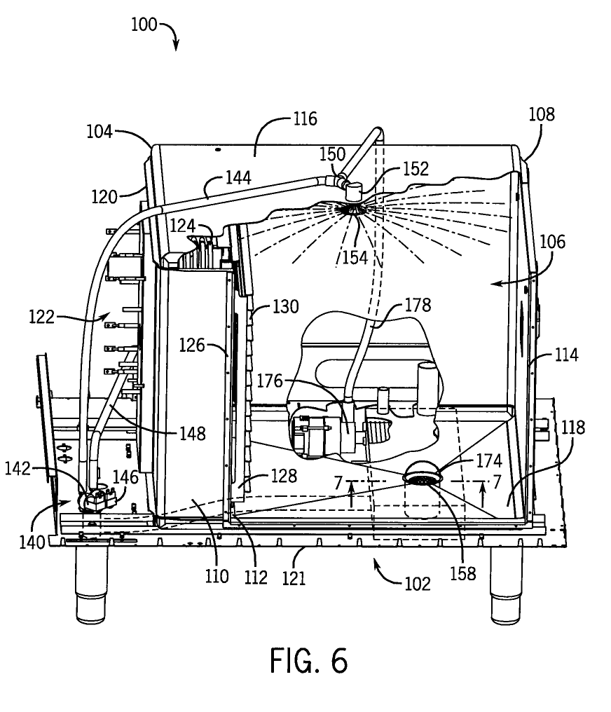

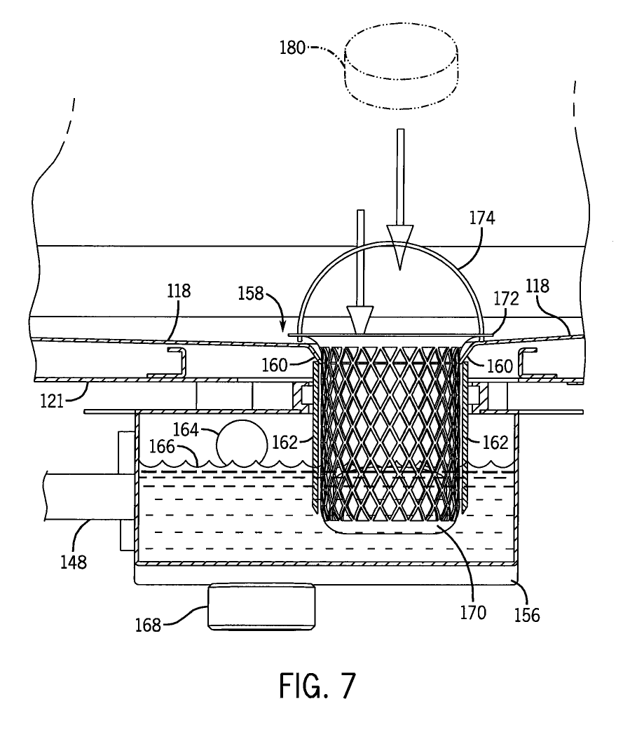

Referring now to FIGS. 6 and 7, a cooking apparatus 100 includes a cleaning assembly 102 according to another embodiment of the present invention. Cooking apparatus 100 includes a housing 104 with a door (not shown) that provides access to a cooking chamber 106 in the interior of housing 104. Housing 104 includes a back wall 108, a front wall 110, a left side wall 112, a right side wall 114, a top wall 116, a bottom wall 118, a left exterior side wall 120, and a bottom exterior wall 121. The door is hingedly attached to front wall 110. The exterior of housing 104 is generally defined by walls 108, 110, 114, 116, and 121. Cooking chamber 14 is generally defined by the door and walls 108, 112, 114, 116, and 118.

Left side wall 112 is offset from exterior wall 120 by a sufficient distance in order to provide a heating assembly 122 capable to prepare food product using radiant, heat, convection, and steam heating. Heating assembly 122 includes a radial fan (not shown) with blades that rotate around a hub, a fan motor (not shown), a heating element 124 looped around the fan blades of the radial fan, and a water atomizer (not shown) disposed proximal to the hub of the radial fan. Heating element 124 is a resistive coil. Heating assembly 122 can provide convection and steam heating as described above with respect to heating assembly 31 of FIGS. 1 and 2. Alternatively, heating assembly 122 can include a gas burner with gas heat exchange tubes to supply the necessary heat for cooking. In another embodiment, cooking apparatus 100 can include a radiant heat assembly, a smoker assembly, and/or a rotisserie assembly.

A cover 126 is attached to left side wall 112 and includes a plurality of apertures (not shown) and that allow for steam and heated air to flow from heating assembly 122 into cooking chamber 106. Cover 126 also includes a grill (not shown) that is axially aligned with the fan hub to provide an air intake for the fan. A rack support 128 extends from cover 126 and includes a plurality of rack shelves 130 that are offset from cover 126. Right side wall 114 includes a corresponding rack support (not shown) that, in addition to rack support 128, support cooking racks and trays placed within cooking chamber 106.

Cleaning assembly 102 cleans cooking chamber 106 and heating assembly 122. Clean assembly 102 is configured to distribute fresh water and detergent-laden water throughout cooking chamber 106, as will be discussed in further detail below. Cleaning assembly 102 includes a fresh water inlet valve 140 that is connected to a fresh water inlet line (not shown) that supplies pressurized clean water. A pump can be used to increase the water pressure in the water inlet line. Fresh water inlet valve 140 is a double solenoid valve including a first valve 142 connected to a spray hose 144 and a second valve 146 connected to a cooling hose 148. The fresh water inlet valve 140 is electrically connected to a controller (not shown), as will be described in further detail below. Alternately, first valve 142 and second valve 146 can be separate single solenoid valves.

Spray hose 142 leads to and is connected to a y-connector 150 that is connected to, or forms part of, a nozzle 152. Nozzle 152 extends through an opening in top wall 116 that is generally centrally located. Nozzle 152 disperses a spray of liquid into cooking chamber 106. Nozzle 152 can be a spray-type nozzle that includes a plurality of ports (not shown) though which liquid is dispersed. Nozzle 152 includes a fluid diverter disc 154 that hangs from nozzle 152 by a post. Fluid diverter disc 154 is positioned in cooking chamber 106 below nozzle 148. Fluid diverter disc 154 diverts the spray of liquid into and/or throughout cooking chamber 106 and heating assembly 122. Fresh water is sprayed out of nozzle 152 when first valve 142 is actuated by the controller. Other embodiments can include more than one nozzle. Cooling hose 148 leads to and is connected to a tank 156, which will be discussed in further detail below. Fresh water is provided to tank 156 when second valve 144 is actuated by the controller.

Tank 156 is mounted underneath cooking chamber 106 and is configured to allow for liquids to drain from cooking chamber 106. A drain 158 extends from a drain opening in bottom wall 118 of cooking chamber 106. Drain 158 also extends through an opening in bottom exterior wall 121. Bottom wall 118 is slanted towards drain 158. Drain 158 includes a drain mouth 160 that opens to a tubular portion 162 that is generally perpendicular to bottom exterior wall 121. Tank 156 is mounted to drain 158. Tubular portion 162 of drain 158 extends into tank 156, which allows for liquids to drain from cooking chamber 106 to tank 156. Tank 156 is rectangular and includes a raised drain opening 164 formed in one of the vertical side walls. Drain opening 164 is connected to a drain that drains to a building's plumbing system. Drain opening 164 is raised to set the height of a water level 166 in tank 156. Tank 156 can be configured to hold a gallon of liquid. Water level 166 is above the end of tubular portion 162 to form a water trap, which allows cooking apparatus 100 to be a closed system. Cooling hose 148 is connected to tank 156 below water level 166. A removable cap 168 is positioned on the bottom of tank 156 to drain all of the liquid from tank 156.

A cylindrical cup 170 is configured sit within drain 158. Cup 170 includes a lip 172 that sits on top of bottom wall 118. A handle 174 is connected to lip 172 and allows a user to remove cup 170 from drain 158 and to place cup 170 into drain 158. The sides and bottom of cup 170 are made of a mesh material that allows for liquids to pass through cup 170 but prevents solids from passing through cup 170. Cup 170 extends below tubular portion 162 of drain 158.

A circulatory pump 176 is connected to tank 156. A circulatory hose 178 is connected between circulator pump 176 and y-connector 150. The circulatory pump 176 pumps liquid from tank 156 to spray nozzle 152, which then disperses the re-circulated liquid into cooking chamber 106. This liquid can then drain back into tank 156 and be re-circulated again by pump 176. The circulator pump 176 is electrically connected to the controller.

To clean cooking apparatus 100, a detergent packet 180 is placed in cup 170, which is then inserted into drain 158. Detergent packet 180 has a thin membrane (not shown) that is water permeable. The thin membrane encases cleaning and rinse agents that dissolve in water. The thin membrane is configured to allow for safe handling of detergent packet 180. The thin membrane is also configured to allow water to enter detergent packet 180 to dissolve the cleaning and rinse agents. Alternatively, the thin membrane may itself be dissolvable while allowing for safe handling. Detergent packet 180 dissolves in the water in tank 156. Pump 176 can cause the detergent-laden water in tank 156 to be sprayed out of nozzle 152 and, thus, randomly sprayed, splashed, and splattered through cooking chamber 106 and heating assembly 122. The detergent-laden water then returns to tank 156 and can be re-circulated by pump 176. Placing detergent packet 180 below cooking chamber 106 and in a tank of water helps to prevent any pieces un-dissolved pieces of detergent from entering cooking chamber 106 and, thus, prevents contamination of food product by any remaining portion of detergent packet 180.

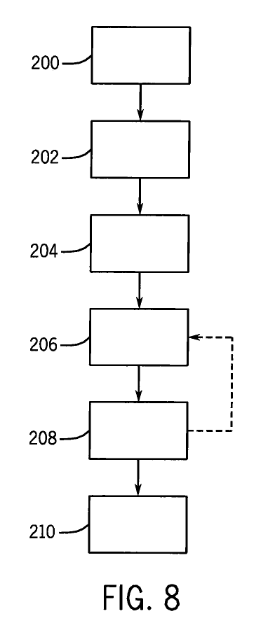

FIG. 8 shows a method of cleaning cooking apparatus 100 of FIGS. 6 and 7. Beginning at start 200, a user puts detergent packet 180 in cup 170, which can already be placed in drain 158 or may then be placed by the user into drain 158. Detergent packet 180 begins to dissolve immediately into the water in tank 156. The user then closes the door and selects a user input that causes the controller to automatically start the cleaning procedure. At step 202, the controller causes heating assembly 122 to provide steam to cooking chamber 106 for a sufficient period of time. The steam loosens contaminants that are baked onto the surfaces of cooking chamber 106. Then, at step 204, the controller actuates pump 176 to cause the detergent-laden water in tank 156 to be sprayed throughout cooking chamber 106 and heating assembly 122. The fan of heating assembly 122 can be running during this cycle to help the sprayed liquid move throughout cooking chamber 106 and heating assembly 122. Additionally, heating assembly 122 may also provide a heating function during this cycle. Pump 176 re-circulates the detergent-laden water for a sufficient time to clean cooking apparatus 100. During the detergent cycle of step 204, fresh water can be introduced to tank 156 by actuating second valve 146, which causes fresh water to flow into tank 156. The fresh water can help to ensure that all of detergent pack 180 is dissolved. At step 206, tank 156 is purged of the detergent-laden water by introducing fresh water to tank 156, which raises the water level in tank 156 and causes excess water to exit tank 156 via drain opening 164. Fresh water can be introduced to tank 156 directly through cooling hose 148 and/or indirectly through spray hose 144 and nozzle 152. Cooling hose 148 can help cool the liquid in tank 156 before the liquid. Once tank 156 has been purged of dirty water, at step 208, pump 176 can be actuated to circulate clean water to nozzle 152, which then rinses cooking chamber 106 and heating assembly 122. Alternately or in addition to the circulated water, fresh water can be introduced to nozzle 152 through spring hose 144. Steps 206 and 208 can be repeated to ensure that cooking chamber 106 and heating assembly 122 are rinsed properly and that cleaning materials are rinsed down the drain connected to drain opening 164. The fan of heating assembly 122 may be actuated to aid the rinsing process. After rinsing, at step 210, the controller can actuate the convection heating mode of heating assembly 122 to dry cooking chamber 106. During the convection heating mode, a fresh air inlet may also be opened to help dry cooking chamber 106. The fresh air inlet is opened because cooking apparatus 100 is normally a closed system that prevents the introduction of fresh air to cooking chamber 106. Air can be exhausted from cooking apparatus 100 through a hood configured to help create the closed system.

Rather than just rinse after the known period of time, the controller can also determine when all of the cleaning and rinse agents have been utilized based on the amount of water dispensed during the cleaning process. Chemical sensors can also be used to determine whether any detergent is present in cooking chamber 106 and/or tank 156.

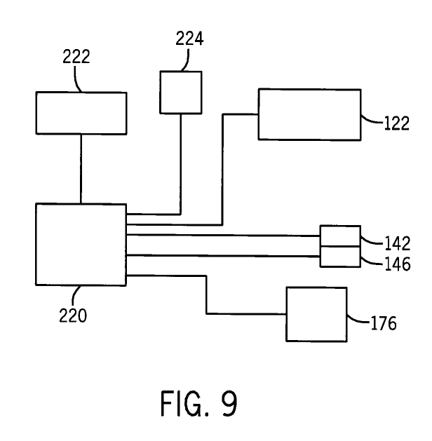

FIG. 9 is a block diagram an electrical system of cooking apparatus 100 including a controller 220 connected to a user input 222, a vent 224, heating assembly 122, first valve 142, second valve 146, and pump 176. Controller 220 is configured to perform the method described in FIG. 8 to clean cooking apparatus 100.

Cleaning assemblies 40 and 102 can be adapted for use with other cooking apparatuses including rotisserie ovens and conventional radiant heat ovens.

While there have been shown and described what is at present considered the preferred embodiments of the invention, it will be obvious to those skilled in the art that various changes and modifications can be made therein without departing from the scope of the invention defined by the appended claims.

We claim:

1. A cooking apparatus comprising:
a cooking chamber having a plurality of surfaces;
a food preparation assembly configured to prepare food product within the cooking chamber;
a water nozzle positioned to direct water into cooking chamber;
a holder configured to hold a detergent packet in a position configured to allow the water to dissolve the detergent from the detergent packet.

2. The cooking apparatus of claim 1, wherein the detergent packet is configured to be handled safely.

3. The cooking apparatus of claim 2, wherein the detergent packet comprises a thin membrane enclosing a water-soluble detergent

4. The cooking apparatus of claim 3, wherein the detergent comprises a cleaning agent and a rinse agent.

5. The cooking apparatus of claim 1, wherein the cooking chamber includes a drain and the holder is a cup configured to be placed in the drain.

6. The cooking apparatus of claim 5, further comprising
a tank positioned below cooking chamber and in fluid communication with the drain, the tank configured to hold a predetermined volume of liquid and to allow for liquids to drain from the cooking chamber to the tank; and
a pump configured to pump liquid from the tank to the water nozzle;
wherein the cup holds the detergent packet in the volume of liquid in the tank.

7. The cooking apparatus of claim 6, further comprising a fresh water line connected to a first valve that is in fluid communication with the nozzle.

8. The cooking apparatus of claim 7, wherein the fresh water line is connected to a second valve that is in fluid communication with the tank.

9. The cooking apparatus of claim 6, wherein the cup comprises a mesh.

10. The cooking apparatus of claim 1, wherein the plurality of surfaces comprises at least one vertical sidewall, the holder being positioned on the at least one vertical sidewall underneath the water nozzle.

11. The cooking apparatus of claim 10, wherein the holder is a tray including a plurality of openings.

12. A method of cleaning a cooking apparatus including a cooking chamber and a heating assembly, the method comprising:
placing a detergent packet in the cooking apparatus;
providing water to the detergent packet to dissolve the detergent packet;
cleaning the cooking chamber with water including detergent dissolved from the detergent packet.

13. The method of claim 12, wherein the detergent packet is placed in a tank positioned below the cooking chamber and water is pumped from the tank to a nozzle that sprays into the cooking chamber.

14. The method of claim 13, further comprising steaming the cooking chamber.

15. The method of claim 13, further comprising rinsing the cooking chamber.

16. The method of claim 13, further comprising providing convection heating during the step of cleaning the cooking chamber.

17. The method of claim 13, further comprising drying the cooking chamber.

18. The method of claim 13, further comprising purging the tank.

19. The method of claim 12, wherein the detergent packet is placed in a tray positioned on a vertical wall within the cooking chamber.

20. The method of claim 19, wherein water is sprayed from a nozzle into the tray.
